(19) United States
(12) Patent Application Publication
(10) Pub. No.: US 2019/0325378 A1
(43) Pub. Date: Oct. 24, 2019

(54) FOOD PROCESSING MANAGEMENT SYSTEM

(71) Applicant: NESTEC S.A., Vevey (CH)

(72) Inventors: Youcef Ait Bouziad, Echandens (CH); Fabien Ludovic Agon, Valeyres-Sous-Rances (CH); Jean-Marc Flick, Pomy (CH); Julien Brinkers, Nyon (CH)

(21) Appl. No.: 16/344,456

(22) PCT Filed: Oct. 23, 2017
(86) PCT No.: PCT/EP2017/076941

§ 371 Date: Apr. 24, 2019

(30) Foreign Application Priority Data
Nov. 1, 2016 (EP) 16196743.5

(51) Int. Cl. G06Q 10/08; G06Q 50/10; A23P 30/10; A23P 20/20

(52) U.S. Cl. CPC G06Q 10/087; G06Q 50/10; A23L 5/00; A23P 20/20; A23P 30/10

(57) ABSTRACT

The invention refers to a food processing management system governing a food processing system (100) for reconstitution and/or structuration and/or texturization of dehydrated food materials such as powders; the management system comprising a control unit (200) retrieving the information from a master recipe (401) from a database (400); the control unit (200) being further connected to a dosing system (50) for effecting the exchange of containers (20) comprising the dehydrated food materials, the control unit (200) further comprising reading means to retrieve the information on identification means in each container (20) in the dosing system (50); the control unit (200) sending operating instructions (101) to manage the food processing system (100) as a function of the master recipe (401).

### FIELD OF THE INVENTION

The present invention is directed to a management system governing the operation of a food processing system reconstituting rehydrated food from dehydrated food material, typically powder.

### BACKGROUND OF THE INVENTION

At present, processed food is becoming more and more widely used in the pursit of saving time and efforts. Present trends of processed foods require that it is made more healthy, adapted to each individual's needs, more convenient, with the least number of processing operations and that the waste is minimised so only the quantity of food to be consumed is ideally prepared.

Currently, known processed foods are bought totally raw or partially cooked and need to be cooked at home by using traditional cooking devices, such as frying devices, microwaves, ovens or the like. The drawbacks of these standard solutions are that, on one side, the food bought is not adapted to the consumer's needs and, on the other side, the consumer has to still process and cook the food at home, so the complete process requires time, further devices and the result is not always satisfactory, which makes the whole process not convenient.

A possibility for preparing tailored food adapted to each individual's needs would be to directly configure, starting from raw ingredients, the food that will be further cooked into a ready-to-eat meal. Some of the solutions known in the state of the art are able to provide systems that can configure the raw meal, but these systems are not able to cook it in the same device, so they need a further processing step: this is cumbersome and not convenient for the consumer and the final result of the meal is not always satisfactory, as different food components arranged in different parts of the meal should be cooked differently, which is not the case with the known home-appliances or would require further devices for specific cooking and a very long processing time. Moreover, a non-adequate cooking would destroy many properties of the meal so processed, therefore making the final result meal not at all satisfactory.

Some of the documents of the prior art show, as already disclosed, systems able to print food according to certain preferences and parameters, but are not able to cook the so prepared raw food. For example, document WO 2010/151202 A1, belonging to Electrolux, discloses a food printer for making 2D and 3D food dimensional shapes of food and binder: a printer head prints small drops of the food and the binder while moving to build the 2D or 3D dimensional shape. Shaping and configuring special 2D and 3D food shapes is disclosed, but no cooking of this food is possible. Similarly, documents CN 104097405 or CN 103932368 disclose systems able to print tailored food but which are not able to further cook this food and provide a cooked meal.

Other trends known in the prior art, particularly relating to 3D printing of food products in more or less complex shapes, print for example sugar or confectionery food products, but do not cook any of the printed food objects: documents US 2014/0154378 A1 or WO 2014/193226 A1 disclose exemplary systems of that.

Another problem arises when providing systems delivering complete food solutions, starting from raw materials, typically dehydrated food materials such as powders, which are first reconstituted and later processed, shaped and optionally also cooked in the system to deliver a final edible food product. Such systems are not made in a fully controllable and automatic way, so they need the input from the consumer in many of the operations carried out.

It would therefore be advantageous to provide a food processing system comprising an integrated control management system such that the input requiered from the consumer is minimized, yet being a convenient and very easy to use system, able to provide a wide range of recipes adapted to each individual's needs, starting from raw base materials and dispensing delicious and healthy ready-to-eat cooked meals.

The present invention aims at these and other objects as will appear in the rest of the present description.

### OBJECT AND SUMMARY OF THE INVENTION

According to a first aspect, the invention relates to a food processing management system governing a food processing system 100 for reconstitution and/or structuration and/or texturization of dehydrated food materials such as powders: the management system comprising a control unit 200 retrieving the information from a master recipe 401 from a database 400; the control unit 200 is further connected to a dosing system 50 for effecting the exchange of containers 20 comprising the dehydrated food materials, the control unit 200 further comprising reading means to retrieve the information on identification means in each container 20 in the dosing system 50. The control unit 200 sends operating instructions 101 to manage the food processing system 100 as a function of the master recipe 401.

Typically, in the food processing management system of the invention, the identification means comprises information on the type and family of the food product material comprised in the container 20, this information being further linked to more detailed information comprised in the database 400.

Preferably, according to the invention, each container in the dosing system 50 is further recognised by an additional single identification ID to the specific container comprising information on the lapsing date of the food product in it and/or the date of opening of the container and/or the remaining quantity of food product in it, for example.

Typically, in the food processing management system of the invention, the master recipe 401 is governed by layers and/or patterns and/or shapes successively deposited by the system 100.

The master recipe 401 preferably comprises information on the food materials needed for preparing the recipe and/or on the layers and/or patterns and/or shapes to configure the recipe, and/or on the types of structures and/or textures for each layer and/or pattern and/or shape deposited, further comprising information on the cooking strategy for each layer and/or pattern and/or shape deposited such as cooking or not and/or cooking procedure (comprising power and time) and/or cooking technology to be activated.

The operating instructions 101 typically comprises information for the operation of the system 100, this information relating to the specific processing of each food material coming from each container 20 before being deposited as a layer and/or pattern and/or shape, and/or on the specific cooking for each of the deposited layers and/or patterns and/or shapes.

Preferably, the information on the specific processing of each food material coming from each container 20 comprises information on the processing speed and/or the processing water flow and/or the processing material flow and/or the processing temperature and/or the processing time and/or the addition of extra fluid such as lubricant, aroma, spices and/or processing shear stress and/or aeration level, or the like.

Also preferably, the operating instructions 101 further comprise information on the relative movement of the system food processing unit 10 depositing the layers and/or patterns and/or shapes and the system depositing area 60 where they are deposited.

In the food processing management system according to the invention, the structure and/or the texture of the layers and/or patterns and/or shapes of the food product deposited by the system 100 typically depend on the processing of the dehydrated food product material and on the later cooking applied to them in the system 100.

According to a possible embodiment, the master recipe 401 to prepare is chosen according to the existing charged containers 20 in the food processing system 100.

Typically, the food processing management system of the invention is further connected to a user's interface 300 in order to receive direct input instructions 301 coming from the system's user, such as on/off of the food processing system 100 and/or master recipe 401 to prepare and/or specific desired processing parameters in the system 100.

It is also possible according to the invention that the master recipes 401 in the database 400 are user modifiable.

New master recipes 401 in the database 400 can also be created by the user or can be remotely downloaded, according to an embodiment of the invention.

Typically, the containers 20 needed to be used by the system 100 are dictated by the master recipe 401 chosen.

### BRIEF DESCRIPTION OF THE DRAWINGS

Further features, advantages and objects of the present invention will become apparent for a skilled person when reading the following detailed description of embodiments of the present invention, when taken in conjunction with the figures of the enclosed drawings.

FIG. 1 shows a functional general overview of a food processing management system according to the present invention.

FIG. 2 shows a representative view of the main components in a food processing system governed by a food processing management system according to the present invention.

FIG. 3 shows a frontal view of the food processing system represented in FIG. 2, governed by a food processing management system according to the present invention.

### DETAILED DESCRIPTION OF EXEMPLARY EMBODIMENTS

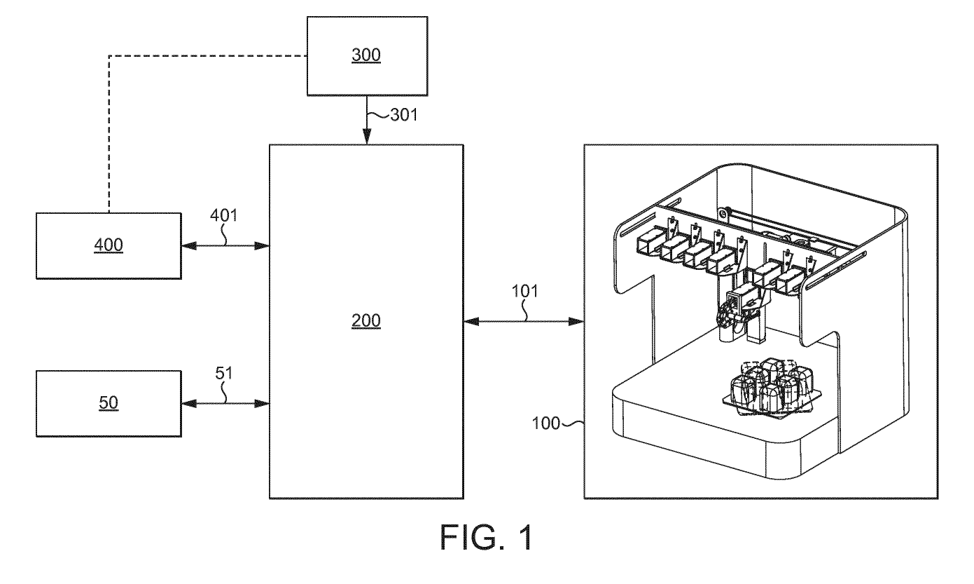

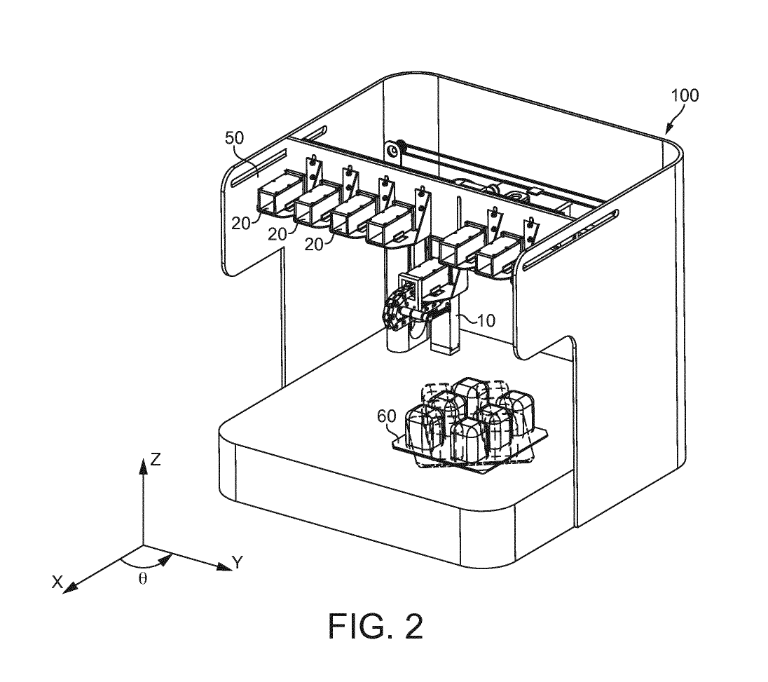

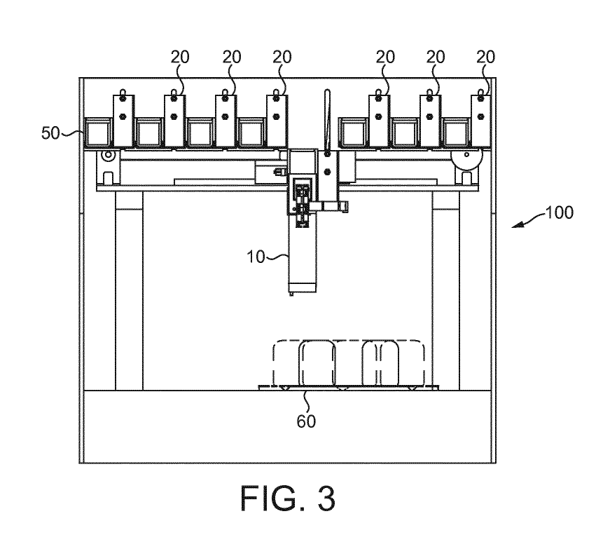

The present invention relates to a food processing management system as schematically represented in FIG. 1. The management system of the invention governs and controls a food processing system 100 allowing reconstitution and/or structuration and/or texturization of dehydrated food materials, typically powders. Further details of the configuration of the system 100 appear in FIGS. 2 and 3 and will be further described in more detail.

The management system of the invention comprises a control unit 200 managing the operation of a food processing system 100 according to data received from a master recipe 401 typically provided by a database 400. The control unit 200 further reads information 51 from containers 20 in a dosing system 50 in the system 100, as schematically represented in FIG. 1. Furthermore, as shown also in FIG. 1, the control unit 200 can be connected to a user's interface 300, receiving input 301 coming directly from the user. The full explanation on how the management system of the invention works will follow.

Typically, the information on the master recipe 401 to be prepared by the system 100 comes from a database 400 (see FIG. 1). It is also possible that this recipe 401 has been downloaded or retrieved remotely, typically downloaded from the cloud, to which the database 400 (or even the control unit 200) can be connected.

Typically, as schematically represented in FIG. 1, the control unit 200 can also be connected to a user's interface 300, so that a user can act directly on it and provide the control unit 200 with input (represented as 301 in FIG. 1): this input information can comprise on/off instructions for the food processing system 100, or a master recipe 401 to be prepared or for example specific parameters to be used in the processing in the system, such as for example temperature of the final product, or crispiness level, or cooking levels of the layers or patterns, etc.

According to the invention, it is also possible that the user modifies directly the recipe 401 in the database 400 or downloaded remotely (as represented by dotted lines in FIG. 1 connecting the user's interface 300 and the database 400).

Referring first to FIGS. 2-3, the food processing system 100 managed will be described in more detail.

In what follows, reconstitution indicates the addition of a liquid, typically water, to an initial powder, further mixing both and obtaining as a consequence a dough-type product. By structuration, the internal physical structure (food engineering or food matrixes) of the dough food material is changed and diverse food structures such as solutions, gels, foams, emulsions, etc. are obtained; the different structures can play a role in improving the consumer's digestion or in the sensorial improvement of sugar and/or fat reductions, as some examples. For obtaining different food structures, diverse physical and/or mechanical procedures can be applied, depending on the intended result, such as aeration, shearing, heating, cooling, etc. Finally, texturization refers to the mouth feeling perception by the consumer, typically if the food product is soft, hard, crispy, crunchy, creamy, fibrous, elastic, foamy, etc. The food texture is highly dependent on the food structure and also on the rheological properties of food, that is, the fluidity and consistency degree of the food material, which typically determine the acceptability of the food products by the consumer.

The food processing system 100 reconstitutes an initial powder, typically by adding water, and also provides different structures and/or textures by the process followed by the food material in a reconstitution food processing unit 10 and/or in a later cooking process following deposition in the system 100.

As shown in FIG. 2, the food processing system 100 comprises:
a dosing system 50 comprising one or a plurality of containers 20, where each container comprises the same or different dehydrated food material, typically a powder;
at least one reconstitution food processing unit 10 to which the containers 20 from the dosing system 50 are connected, so that the powder is mixed with a liquid, typically water, the powder being processed in different ways depending on the intended final food structure and/or texture, and is later deposited;
a depositing area 60 where the formed food from the processing unit 10 is dispensed.

In the system 100 of the invention, there is a dosing system 50 comprising typically a plurality of containers 20, each container comprising a different dehydrated food material, typically a powder. The containers can also comprise certain inclusions or fibres together with the powder material, so that specific fibrous textures for example are provided in the food material. Depending on the recipe 401 of the product to be prepared in the system, different containers 20 will be successively plugged to the reconstitution food processing unit 10, so that diverse successive patterns or layers of different or the same food material will be processed and deposited by the unit 10 on the depositing area 60. This is to say, the containers used are dictated by the recipe 401 to be prepared.

Even when not shown in FIGS. 2-3, the system 100 will typically be provided with cooking means that can be selectively activated or not, to cook part or the complete food layers or patterns deposited in the area 60. Depending on the recipe, the cooking means will be activated or not, during a certain time, reaching a certain temperature, etc. Typically, the cooking means will comprise surface cooking means and core cooking means. The surface cooking means will typically be selected from: a broiler element, hot air convection and/or infrared radiation means with adequate wavelength. For core cooking means, the present invention will typically use infrared radiation means at appropriate wavelength and/or microwave means, either using a magnetron or solid state microwaves.

Each container 20 in the dosing system 50 typically comprises identification means 51 (typically a code) with information on the ingredients comprised inside and also with information on the specific container number or reference, useful for containers management purposes.

Therefore, the identification means 51 first typically comprise information on the type and family of the food product material comprised in the container 20, this information being further linked to more detailed information comprised in the database 400 (or also downloaded in the database 400 remotely). For example, the information on the identification means 51 will indicate the control unit 200 that a certain container 20 comprises a product such as carrot or potatoes or beef in powder: the database 400 (or remotely downloaded) will indicate the control unit 200 further information on the composition, viscosity or related recipes for example that can be prepared with such food product in the container. Depending on how the same food product is processed in the processing unit 10 (typical parameters are temperature, time, shear stress, water flow in the unit 10, product flow in the unit 10, processing speed of the unit 10, additional fluid added, etc.) a different structure and/or texture of it can be provided in the end, for example a pure, a soup, a foam, a gel, etc. This structuration and/or texturization will be governed by the master recipe 401. The processing parameters vary depending on the structure and/or texture to deliver; the cooking strategy will also vary depending on this structure and/or texture intended for each of the layers or patterns: typically, to obtain a foam structure, aeration and high shear shall be provided to the food product; for a gel, heating and later cooling down will be required, addition of dried pieces will provide a crunchy texture and specific final heating will make the product crispy.

Furthermore, each container 20 is provided with an additional single identification ID to the specific container (also comprised for simplicity in the same reference of identification means 51) comprising information on usage of the container itself in the management system. This information can typically comprise the lapsing date of the food product in it, the date of opening of the container (i.e. first date when this container was used to deliver powder into the unit 10) or the remaining quantity of food product in it, for example. Typically, this information will be used to govern or control the management of the different containers 20 in the dosing system 50.

The food processing system 100 is configured in such a way that it allows either the processing unit 10 or the depositing area 60 or both move with respect to each other, in such a way that different shapes or patterns of food can be deposited and built in the depositing area 60, typically in order to shape 3 dimensional food shapes onto this area. In a preferred embodiment, the system 100 will be provided with a processing unit 10 that will be fix, while the depositing area 60 will be able to move in X and/or Y and/or Z and/or will be able to rotate an angle theta θ in the XY deposition plane. This configuration allows any possible configuration of deposited food materials in 3-dimensions on the depositing area 60.

Another possible embodiment will allow the processing unit 10 move horizontally in Y while the depositing area 60 will be able to move vertically in Z or will be able to rotate in the plane XY an angle θ. The combination of these three movements allows the deposition of any 3-dimensions shape on the area 60.

First, when operating a food processing system 100, the control unit 200 needs to retrieve the information on the master recipe 401: this recipe will provide the unit 200 with the information on the final food product to be delivered by the system and also with the information on how to operate the system 100 in order to achieve such final product. Regarding the information on the final product targeted, the recipe 401 typically provides the control unit 200 with: the layering and pattern configurations of the final food product; the cooking (if any) and cooking level of each of these layers; the food material configuring each of the layers or patterns deposited; the texture and/or hydration level and/or structure of each of the layers or patterns deposited.

The master recipe 401 further provides the control unit 200 with the information on how to operate the system 100 so that it delivers a final edible food product. The control unit 200 therefore governs the system 100 by a set of operating instructions 101, these instructions intending the following:
depending on the hydration level and/or texture and/or structure of each one of the layers, how to process each material in the processing unit 10, typically: the processing speed/rate of the processing unit 10, the product flow rate into the processing unit 10, the liquid flow rate in the processing unit 10, the product temperature, if any additional liquid needs to be added, such as aromas, lubricants, or specific adding such as spices or the like;
the relative movement of the processing unit 10 with respect to the depositing area 60, so that different layers and/or patterns and/or shapes can be formed in the depositing area 60, typically configuring 3-dimensional shapes;
the cooking strategy (if any cooking is needed for each of the layers or part of each of the layers) for each of the layers and/or patterns and/or shapes deposited, such as cooking or not and/or cooking procedure (comprising power and time) and/or cooking technology used.

In the management system of the invention, the containers 20 needed to be used by the dosing system 50 are dictated by the master recipe 401 chosen to be prepared. Also, another possibility is that the management system proposes the user with the recipes able to be prepared according to the existing containers 20 in the dosing system 50 of the system 100.

Although the present invention has been described with reference to preferred embodiments thereof, many modifications and alternations may be made by a person having ordinary skill in the art without departing from the scope of this invention which is defined by the appended claims.

1. Food processing management system governing a food processing system for reconstitution and/or structuration and/or texturization of dehydrated food materials:
the management system comprising a control unit retrieving the information from a master recipe from a database;
the control unit being further connected to a dosing system for effecting the exchange of containers comprising the dehydrated food materials, the control unit further comprising a reader to retrieve the information on an identification mean member in each container in the dosing system; and
the control unit sending operating instructions to manage the food processing system as a function of the master recipe.

2. Food processing management system according to claim 1 wherein the identification member comprises information on the type and family of the food product material comprised in the container, this information being further linked to more detailed information comprised in the database.

3. Food processing management system according to claim 1 wherein each container in the dosing system is further recognised by an additional single identification ID to the specific container comprising information.

4. Food processing management system according to claim 1 wherein the master recipe is governed by layers and/or patterns and/or shapes successively deposited by the system.

5. Food processing management system according to claim 4 wherein the master recipe comprises information selected from the group consisting of the food materials needed for preparing the recipe, the layers and/or patterns and/or shapes to configure the recipe, the types of structures and/or textures for each layer and/or pattern and/or shape deposited, the cooking strategy for each layer and/or pattern and/or shape deposited such as cooking or not and/or cooking procedure and/or cooking technology to be activated.

6. Food processing management system according to claim 4 wherein the operating instructions comprises information for the operation of the system, this information relating to the specific processing of each food material coming from each container before being deposited as a layer and/or pattern and/or shape, and/or on the specific cooking for each of the deposited layers and/or patterns and/or shapes.

7. Food processing management system according to claim 6 wherein the information on the specific processing of each food material coming from each container comprises information on the processing speed and/or the processing water flow and/or the processing material flow and/or the processing temperature and/or the processing time and/or the addition of extra fluid such as lubricant, aroma, spices and/or processing shear stress and/or aeration level, or the like.

8. Food processing management system according to claim 6 wherein the operating instructions further comprise information on the relative movement of the system food processing unit depositing the layers and/or patterns and/or shapes and the system depositing area where they are deposited.

9. Food processing management system according to claim 4 wherein the structure and/or the texture of the layers and/or patterns and/or shapes of the food product deposited by the system depend on the processing of the dehydrated food product material and on the later cooking applied to them in the system.

10. Food processing management system according to claim 1 wherein the master recipe to prepare is chosen according to the existing charged containers in the food processing system.

11. Food processing management system according to claim 1 wherein it is further connected to a user's interface in order to receive direct input instructions coming from the system's user.

12. Food processing management system according to claim 1 wherein the master recipes in the database are user modifiable.

13. Food processing management system according to claim 1 wherein new master recipes in the database are created by the user or are remotely downloaded.

14. Food processing management system according to claim 1 wherein the containers needed to be used by the system are dictated by the master recipe chosen.
